(19) United States
(12) Patent Application Publication
(10) Pub. No.: US 2019/0334426 A1
(43) Pub. Date: Oct. 31, 2019

(54) Vector haptic feedback by perceptual combination of cues from mechanically isolated actuators

(71) Applicant: The Board of Trustees of the Leland Stanford Junior University, Stanford, CA (US)

(72) Inventors: Heather Culbertson, Los Angeles, CA (US); Allison M. Okamura, Mountain View, CA (US); Julie Walker, Stanford, CA (US)

(21) Appl. No.: 16/462,224

(22) PCT Filed: Nov. 29, 2017
(86) PCT No.: PCT/US2017/063667

§ 371 Date: May 18, 2019

Related U.S. Application Data
(60) Provisional application No. 62/428,807, filed on Dec. 1, 2016.

(51) Int. Cl. H02K 33/18; G08B 6/00; A63F 13/285

(52) U.S. Cl. CPC H02K 33/18; A63F 2300/8082; A63F 13/285; G08B 6/00

(57) ABSTRACT

Vector haptic feedback cues are provided by combining force cues from two or more 1-D actuators driven with asymmetric vibrations. In order for this combination to work properly, it is important for the actuators being combined to be mechanically isolated from each other. This combination can be a perceptual combination of force cues provided to different locations on the same body part of a user.

### FIELD OF THE INVENTION

This invention relates to haptic feedback.

### BACKGROUND

When providing haptic force feedback to a user, it is often desirable to provide vector feedback (i.e., feedback having a 2-D or 3-D direction). Two basic approaches have been considered for this. In one approach, a single device with the required several degrees of freedom is created by mechanically coupling together multiple actuators. Leonardis (2015 IEEE World Haptics Conference) is an example of this approach, where three degrees of freedom are provided with three actuators at a single point of contact. This kind of approach generally requires complex mechanical design of the device. Another approach is to use two or more 1-D actuators to provide vector feedback by combining their outputs, e.g. as proposed in U.S. Pat. No. 8,981,682 by Delson et al.

### SUMMARY

However, we have found that a straightforward implementation of the idea of providing vector feedback by combining the outputs of two or more 1-D actuators at different points of contact, e.g., by rigidly mounting the several actuators spaced apart on a common substrate, does not work well in practice. Mechanically isolating the actuators from each other is important for getting this idea to work. Once mechanical isolation is provided, we have found that it is not necessary for the actuators to be co-located to provide the desired vector feedback. The human touch perception system can provide a vector force sensation even from two 1-D actuators that are some distance apart, but are attached to the same part of the body.

Another important aspect of this work is that this device is ungrounded. This is very different from traditional haptic force feedback devices, which sit on a table and through the use of motors and linkages utilize reaction forces from the table to push on the user. However, with ungrounded devices, there is nothing physical for the device to push back against so the net force is zero. This makes it much more difficult to apply a force sensation to the user. In this work, asymmetric vibrations are used to provide such ungrounded force sensations to the user.

In this work, two or more 1-D actuators are driven using asymmetric vibrations to display two or more degrees of force or rotation to a user. 1-D actuators are linear actuators that are capable of displaying cues in only a single direction per actuator. Therefore, at least one actuator is needed for each force direction desired and two actuators are needed for each rotation direction desired.

Asymmetric vibrations are defined as vibrations that have a larger amplitude in one direction than in the opposite direction. When the actuator is held in the user's hand, the vibrations are translated to skin displacement. The skin displacement is larger in the direction of the larger vibration (positive) amplitude, and smaller in the opposite (negative) direction. The user then perceives a pulling force sensation in the direction of the larger displacement. The strength of the pulling sensation is dependent on the difference in amplitude between the positive and negative skin displacements. Thus asymmetric vibrations can be used to provide a pushing or a pulling sensation along the line of motion of a 1-D actuator.

The pulling force induced by the asymmetric vibrations is highly dependent on the profile of skin deformation that is presented to the user. Our tests have shown that when the actuators are rigidly mounted to a device (such as on a plate or in a handle), the required profile of the vibrations is not maintained due to the propagation of the vibrations through the device itself. The vibrations are instead spread out and propagate in multiple directions, not just in the desired direction of the pulling force. This alteration in the vibrations is even more pronounced when multiple actuators are attached to the device because they disrupt the linear progression of vibrations through the device. Therefore, rigidly attaching multiple actuators to a device does not allow for a simple vector sum of vibrations to display multiple directions.

Instead of using a rigid attachment of the actuators, this work relies on mechanically isolating the actuators from one another. Here “mechanically isolated” means 15 dB or more of vibration attenuation from one actuator to another in a frequency range from 0 to 100 Hz. High attenuation at frequencies above 100 Hz is not necessary because the frequencies at which the actuators are driven are less than 100 Hz. This can take the form of:

a) Attaching multiple actuators to a rigid device via a flexible medium to allow the actuators to move independently from one another; or
b) Attaching multiple actuators to different parts on the body.

One successful implementation of Method (a) has taken the form of two voice coils mounted between two rigid plates with very stretchy layers of silicone rubber separating the voice coils from the rigid plates, as in the example of FIGS. 2C-D. This method allows us to mount the actuators on or in a rigid device. The constraints are that the actuators should be free to move at least 1 mm relative to one another and to the device itself. The actuators should be flexibly coupled to the device and should be mechanically isolated from one another.

One instantiation of Method (b) is presented in detail below, where three actuators were mounted on the fingers to display three directions of force information. Since the actuators were mounted to this skin, which is naturally stretchy, they were free to move independently from one another. Even when two actuators were mounted on the same finger, we did not experience any issues with interference of cancellation of signals between the different actuators. When signals are displayed from two actuators at the same time, users perceive a pulling force in a direction between the two axes of motion of the two individual actuators. Therefore, even though the users are perceiving the vibrations on two different locations on the body, their brain can combine the two signals and they perceive one “effective” force.

FIG. 1A shows a first embodiment of the invention. Here two or more 1-D actuators 104 and 106 are driven with asymmetric vibrations to provide force cues 108 and 110 to a user 102. At least two of the actuators are configured to provide a vector force cue by combination of their outputs, as shown in this example where vector force cue 112 is a combination of force cues 108 and 110. As indicated above, vector force cue 112 can be a perceptual combination of force cues 108 and 110. The two or more 1-D actuators are mechanically isolated from each other.

The example of FIG. 1B shows one way to achieve this mechanical isolation. Here elastic fabric members 120 and 122 are configured to hold actuators 104 and 106, respectively, in contact with skin of user 102. Preferably the elastic fabric members do not stretch in actuation directions of their corresponding 1-D actuators. Alternatively, 120 and 122 in this figure could be elastic sleeve members configured to hold the actuators in contact with skin of a user in operation.

Another way to achieve mechanical isolation is shown on FIGS. 2A-B. Here FIG. 2A is a top view and FIG. 2B is a side view. Here 202 is a rigid substrate, and actuators 104 and 106 are mounted to substrate 202 via a flexible and mechanically isolating medium 204 configured to mechanically decouple the two or more actuators from each other.

A further way to achieve mechanical isolation is shown on FIGS. 2C-D. Here FIG. 2C is a cross section view as indicated by line 220 and FIG. 2D is a side view. Here 212 and 214 are rigid plates, and actuators 216 and 218 are mounted between the plates via flexible and mechanically isolating pads 222, 224, 226, 228 configured to mechanically decouple the two or more actuators from each other. A device of this kind can be held by the user or be strapped to a part of the user's body. Vibrations from the actuators can pass through plates 212 and 214 to be perceived by the user.

Practice of the invention does not depend critically on the location of the actuators, although they should be disposed on the same body part in order to provide perceptual force cue combination as described above. Suitable body parts include, but are not limited to: finger, hand, wrist, arm, head, neck, ankle, foot, knee, and chest. See FIGS. 7A-12B.

Rotation cues can be provided in connection with this vector force combination idea by providing at least one pair of linear actuators disposed to deliver substantially equal and opposite forces to skin of a user to create a haptic rotation cue. See FIG. 4D.

Although the detailed example given below uses voice coils for the 1-D actuators, practice of the invention does not depend critically on the choice of actuator. Any other 1-D actuator capable of being driven with asymmetric vibrations can be employed, including but not limited to: an oscillating mass on a spring where the position of the mass is controlled by a motor or a voice coil; linear servos; rotary motors having a mechanical linkage to translate rotation to displacement of skin; rotary servo motors having a mechanical linkage to translate rotation to displacement of skin; and linear resonant actuators.

### BRIEF DESCRIPTION OF THE DRAWINGS

FIGS. 1A-B show a first embodiment of the invention.

FIGS. 2A-B show a second embodiment of the invention.

FIGS. 2C-D show a third embodiment of the invention.

FIG. 3 shows an exemplary asymmetric vibration waveform.

FIGS. 4A-D show actuator arrangements for an experimental demonstration.

FIG. 5 shows translation results for the experiments of FIGS. 4A-D.

FIG. 6 shows rotation results for the experiments of FIGS. 4A-D.

FIGS. 7A-C show several configurations for actuators on the hand of a user.

FIGS. 8A-D show several configurations for actuators on the arm of a user.

FIGS. 9A-C show several configurations for actuators on the head or neck of a user.

FIGS. 10A-C show several configurations for actuators on the ankle or foot of a user.

FIGS. 11A-C show several configurations for actuators on the leg or knee of a user.

FIGS. 12A-C show several configurations for actuators on the chest or abdomen of a user.

FIGS. 13A-C show several linear actuators suitable for use in embodiments of the invention.

FIGS. 14A-D show several linear actuators suitable for use in embodiments of the invention, where a rotary drive motion is converted to linear actuation.

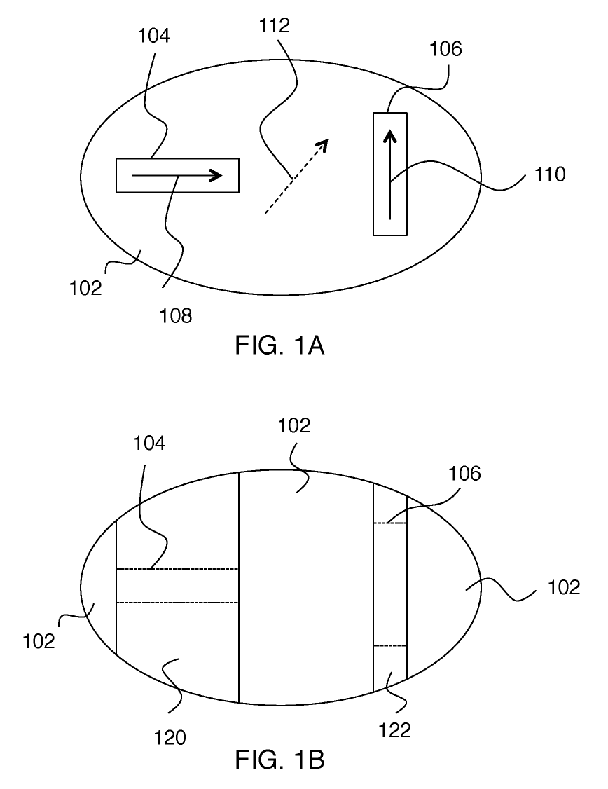

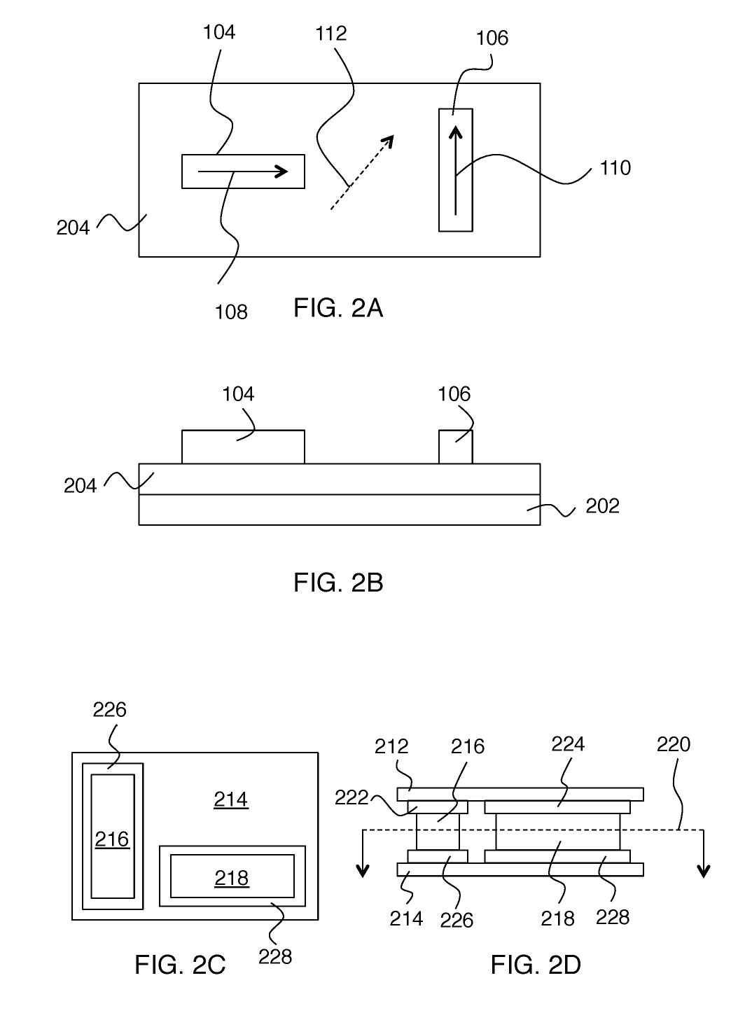

### DETAILED DESCRIPTION

### A) Introduction

Humans depend heavily on visual information to guide their motion in both large scale navigation through an environment and smaller scale motor tasks. However, there are tasks during which a user's visual attention is needed elsewhere, such as when a pedestrian navigates around a city by GPS. By leveraging the sense of touch to replace visual guidance with haptic guidance cues, we can free visual attention for other purposes.

This mapping of visual information to the sense of touch, however, is difficult due to the limited degrees of freedom available. Typically, haptic guidance systems require at least one actuator per direction. This one-to-one mapping quickly limits the complexity of guidance cues that can be displayed. The system we present in this work requires only six actuators to display twelve distinct direction cues, a marked improvement over traditional haptic feedback methods.

A haptic guidance system's usability also depends on the method and location of attachment to the skin. The haptic sensations are preferably easily sensed, so the actuators should be located on a part of the body with a high density of mechanoreceptors. The guidance system should also be unobtrusive and should not drastically hinder everyday activities. Although hands have high densities of mechanoreceptors, holdable guidance devices are not ideal because they monopolize the use of that hand. In contrast, our system directly attaches the actuators to the fingertips. This allows us to leverage the high sensitivity of the fingertips that is due to the large number of mechanoreceptors, and additionally the actuators are small and allow the hand freedom of motion.

Haptic guidance has been shown to be effective in tasks where cognitive load is high. In order to alleviate some of the cognitive load, the haptic guidance cues should be easy to recognize and interpret. However, many traditional haptic guidance systems rely on patterned or sequential activation of multiple actuators. These patterns can be difficult to decipher due to the close activation in location and/or time of multiple actuators. Our system creates intuitive pulling and twisting sensations that compel users to move in the desired direction, rather than requiring users to interpret arbitrary cues.

In this work, we present a wearable haptic device that can provide three-degree-of-freedom guidance through the use of asymmetric vibrations. It can provide either translation or rotation cues to a user's hands for navigation. Future uses of the device include guidance for body pose during rehabilitation and training. We show that users can identify both translation and rotation directions, and we discuss the perceptual concepts that affect the ability of wearers to perceive asymmetric vibrations.

### B) Related Work

### B1) Vibration Guidance

Much of the prior work in haptic guidance has focused on vibration because it is cheap, lightweight, and easily scalable. Simple symmetric vibrations are capable of communicating information to the user about their current or desired state in navigational or other guidance tasks. However, these high-frequency (typically 100-250 Hz) vibrations are limited by adaptation of the skin through prolonged use and by difficulty localizing individual vibration tactors. Furthermore, since most vibration actuators provide only a binary cue (on or off) a separate actuator is required for each direction.

### B2) Asymmetric Vibrations

Recently, researchers have explored a method of using vibration to create guidance cues that are more intuitive than previous vibration feedback methods. Asymmetric vibrations, which are characterized by large positive acceleration peaks and small negative acceleration peaks, provide a compelling sensation of being pulled in the direction of the large acceleration. This sensation is in stark contrast to the simple binary cues presented by standard vibration feedback. It eliminates the interpretation step required for binary vibration cues and can present two directions with one vibration actuator.

This work presents the design and analysis of WAVES, a Wearable Asymmetric Vibration Excitation System for displaying three-dimensional translation or three-dimensional rotation cues. The system avoids many of the inherent limitations of holdable devices, such as requiring specific hand positions and constraining the motion of the hand, by directly attaching the actuators to the hand. Building on the success of previous asymmetric vibration systems, WAVES provides intuitive direction cues by creating salient pulling and twisting sensations.

### C) Creating Asymmetric Vibrations

This section presents our methods for creating an ungrounded pulling or twisting sensation using a voice coil actuator that is vibrated asymmetrically.

### C1) Hardware

We generate asymmetric vibrations using a Haptuator Mark II voice coil actuator (Tactile Labs). We chose this actuator for its low mass (9.5 grams), small size (9×9×32 mm), and frequency characteristics (fᵣₑₛ≈110 Hz). The Haptuator includes a permanent magnet suspended inside an electromagnetic coil between two flexure membranes.

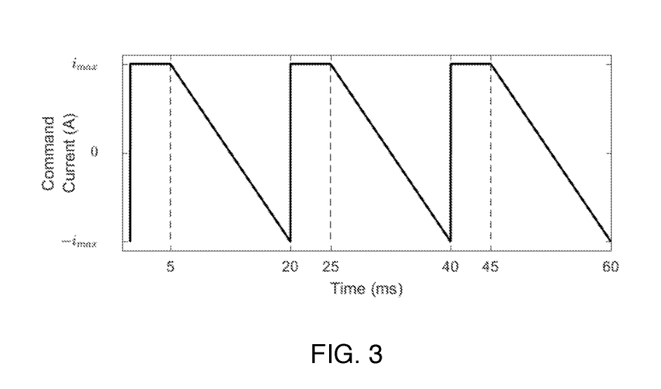

The asymmetric vibrations are generated by moving the magnet unevenly along the axis of the actuator. Our previously reported work determined that an optimum signal to drive the voice coil actuators to create a salient pulling sensation is the step-ramp current pulse shown in FIG. 3. The step portion of the signal pushes the magnet quickly in one direction, creating a large force pulse. The ramp portion of the current pulse then slowly returns the magnet to its starting position, creating a smaller force that occurs over a longer period of time.

The commanded current signal is scaled and converted to a voltage before being output at a 1000 Hz sampling frequency through an analog output pin on a Sensoray 826 PCI card. The output voltage is then passed through a custom-built linear current amplifier using a power op-amp (LM675T) with a gain of 0.5 A/V.

### C2) Perception

Although the net force over the duration of a cycle is zero, the difference in magnitude between the force pulses during the step and the return of the magnet causes a net pulling sensation in the direction of the larger force pulse. When the actuator is held in contact with a person's skin, the force pulses deform the skin. The faster skin deformation due to the step is sensed more strongly than the slower skin deformation of the return, intensifying the perception of the pulling.

The timing of the current pulse is tuned to maximize the strength of the pulling sensation by optimizing the ratios of positive to negative peak skin displacements and skin displacement speeds. For the actuator used in this work, we determined the optimal timing to be tₛₜₑₚ=5 ms, tᵣₐₘₚ=15 ms. These asymmetric vibrations at 50 Hz are sensed by both the Meissner corpuscles, which are sensitive to dynamic skin deformation, and the Pacinian corpuscles, which are sensitive to high-frequency vibrations. However, the Pacinian corpuscles do not sense the direction of the vibrations, so only the Meissner corpuscles are responsible for the pulling sensation induced by the asymmetric vibrations. The magnitude of the skin deformation (≈0.25 mm) is well above the detection threshold.

The strength of the perceived pulling sensation is not a constant force, and has been shown to increase when the user moves their limb. This is contrary to traditional vibration feedback systems, in which the accuracy of the cue is diminished due to motion. This phenomena of increased perception with motion deserves further study.

Twisting sensations are created by playing asymmetric vibrations in opposite directions and in slightly offset locations on the body. The actuators should be parallel to one another so that the pulling sensations create a perceived force couple. They should be positioned close enough that the sensation from the two actuators is perceived as coming from the same area of skin, but also be far enough apart so that the receptive fields of the Meissner corpuscles stimulated by each actuator do not overlap. Furthermore, the actuators are preferably timed so that the force peaks occur at the same time or the overall sensation will be diminished.

### D) Wearable System

Previous asymmetric vibration systems were holdable. Here we describe our methods for creating compelling wearable systems, which have three degrees of freedom—more than any previous holdable system.

### D1) Mounting Locations

In order to induce a strong pulling or twisting sensation, we chose mounting locations that maximized the number of mechanoreceptors stimulated. As discussed earlier, asymmetric vibrations are sensed by the Meissner Corpuscles. Previous literature reports have determined that the human hand has significantly higher concentration of Meissner Corpuscles along the radial nerve and on the distal end of the thumb, index, and middle fingers. Therefore, in creating our wearable device, we focused on these areas for actuator placement.

Humans are more sensitive to tangential skin displacement than normal skin displacement. Therefore, to maximize the pulling sensation, the actuators are preferably placed so that they displace the skin tangentially. The optimal actuator placement is different for displaying translation or rotation cues.

### D1a) Translations

The density of mechanoreceptors is higher on the fingers than the rest of the hand. Our pilot investigations of actuator placement confirmed that the pulling sensation was strongest when the actuators were attached to the fingers. Creating a system capable of providing cues for multiple degrees of translation required us to place actuators on multiple fingers.

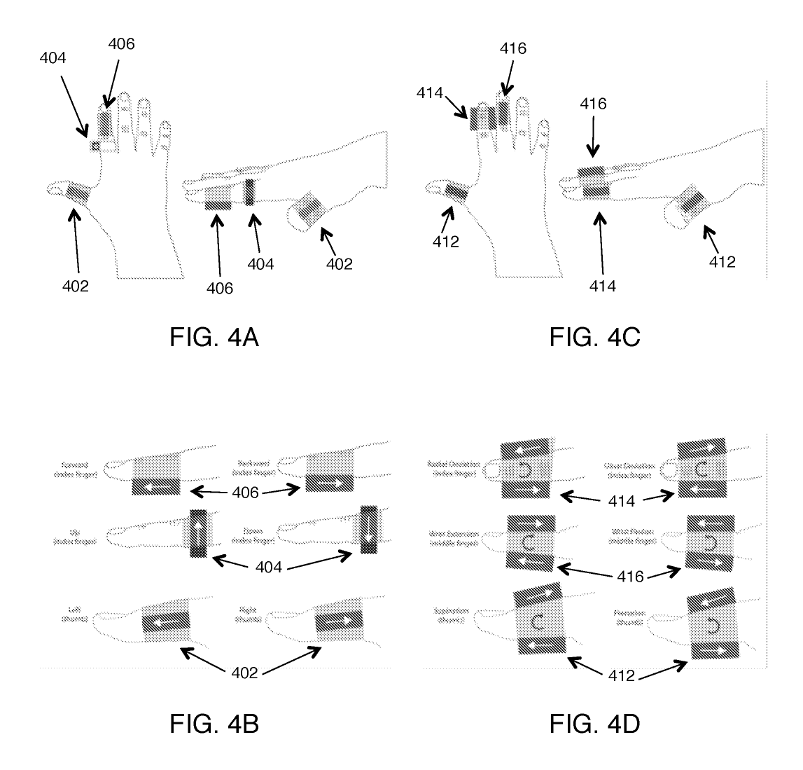

As discussed above, the vibrations are transmitted most completely from the actuator to the skin when the contact between actuator and skin is maximized. To display cues for three orthogonal directions, we added actuators to the side of the thumb, and the bottom and side of the index finger, as shown in FIGS. 4A and 4B. The thumb is held out at an approximately right angle to the rest of the fingers and is used to display the left-right cues from actuator 402. A second actuator 406 is attached to the bottom of the index finger and is used to display the forward-backward cues. These two actuators are attached using elastic straps. A third actuator 404 is attached to the side of the index finger using a silicone rubber sleeve and is used to display the up-down cues. A piece of Very High Bond (VHB, 3M) tape further secures this actuator to the finger to increase the skin deformation and ensure that the actuator does not slip against the skin.

### D1b) Rotations

Twisting sensations are created using pairs of parallel actuators on opposite sides of the fingers that display asymmetric vibrations in opposing directions. Rather than simply doubling the actuators on the translation configuration, we chose mounting locations specifically with rotations in mind. Our system is capable of displaying six directions of wrist rotation cues: radial deviation, ulnar deviation, wrist extension, wrist flexion, supination, and pronation. Three actuators pairs are attached to the thumb, index finger, and middle finger of the right hand, as shown in FIGS. 4C and 4D.

Actuator pair 414 is attached to the left and right of the index finger to display radial-ulnar deviation cues. When the left actuator is pulsed proximally and the right actuator is pulsed distally, the finger feels a counter-clockwise twisting sensation, which signals radial deviation. When the left actuator is pulsed distally and the right actuator is pulsed proximally, the finger feels a clockwise twisting sensation, which signals ulnar deviation.

Actuator pair 416 is attached on the top and bottom of the middle finger to display wrist extension-flexion cues. When the top actuator is pulsed proximally and the bottom actuator is pulsed distally, the finger feels an upwards tilting sensation, which signals extension. When the top actuator is pulsed distally and the bottom actuator is pulsed proximally, the finger feels a downwards tilting sensation, which signals flexion.

Actuators pair 412 is attached to the top and bottom of the thumb to display the supination-pronation cues. When the top actuator is pulsed proximally and the bottom actuator is pulsed distally, the thumb feels an upwards tilting sensation, which signals supination. When the top actuator is pulsed distally and the bottom actuator is pulsed proximally, the thumb feels a downwards tilting sensation, which signals pronation.

### D2) Mounting Methods

The materials used for mounting the actuators to the hand are preferably lightweight because the amount of skin deformation is dependent on the mass that the actuator moves. Furthermore, the vibrations should maintain their commanded shape and direction when transmitted to the skin. Rigid components were tested as part of the mounting hardware, but they distorted and spread out the vibrations in multiple directions, causing the user to feel simple vibration rather than pulling or twisting. Instead, we found that soft materials such as fabric and silicone rubber perform better at maintaining vibration directionality and were better choices for attaching the actuators.

The amount of skin displacement depends on the stiffness and damping properties of the skin. The damping of the skin increases with increasing normal force, which leads to decreased skin displacement overall. Therefore, the actuators should not be too tightly coupled to the hand. However, sufficient normal force is needed to ensure that the actuator remains in contact with the skin so that vibrations can be transmitted properly.

In our design, elastic straps were used to attach the actuators to the hand. The straps were the same width as the actuator to ensure that the normal force was evenly spread over the length of the actuator and all points on the surface of the actuator were in contact with the skin. The elastic straps did not stretch in the direction of actuation, so all force from the actuator was transmitted to skin deformation. The tightness of the straps were chosen so that the actuator maintained contact with the skin, but did not cause discomfort. A silicone rubber sleeve was used to attach one of the actuators mounted normal to the side of the finger, as shown in the Up and Down (index finger) cases in FIGS. 4A-B, in order to increase the amount of skin deformation. The silicone damped out vibration too much for actuators mounted tangential to the finger.

### E) Experimental Methods

We tested the effectiveness of our device at displaying rotation and translation cues through a user study. We recruited 12 right-handed participants (7 male, 5 female, 23-42 years old). Six of the participants had prior experience with haptic devices. The protocol was approved by the Stanford University Institutional Review Board (Protocol Number 22514), and all participants gave informed consent.

### E1) Experiment Set-Up

Participants sat at a table with the actuators attached to their right hand. They wore noise-canceling headphones so they could not use auditory cues, and they closed their eyes so they could not use visual cues to distinguish the directions. During the study, participants held their hand in front of their body and above the table with their palm faced downward. Participants began each trial with their hand held in the same neutral position, but were allowed to move their hand during the trial.

### E2) Experimental Procedure

Participants identified translation and rotation cues in two separate experiment blocks. Both blocks followed a forced-choice paradigm where participants received a cue and responded with one of six possible directions. Before each block, participants were trained on the different direction cues. They were first allowed to feel all six directions shown in FIGS. 4A-D until they felt comfortable with their ability to identify the cues. translation block: left, right, forward, backward, up, down rotation block: radial deviation, ulnar deviation, extension, flexion, pronation, supination

Since the strength of the pulling or twisting sensation is dependent on actuator placement, adjustments to actuator location and orientation were made as needed until the sensation was maximized. Next, participants received further training by completing 18 practice trials (3 trials for each condition) and received feedback about whether they had responded correctly. After training, participants completed 72 pseudorandom experimental trials (12 trials for each condition). For each trial, a 3-second-long cue was played, and participants were allowed to feel each cue up to three times before answering. Participants verbalized their answer, and the experimenter input the response into the computer. Participants were randomly assigned the order of the experimental blocks, with half of the participants completing the translation block first.

The participants rested for five minutes between the two experimental blocks to allow them to recover from any vibration adaptation that had occurred. Recovery from vibration adaptation is known to take approximately half as long as the length of the original vibration signal. Since two actuators were used for the rotation directions, the amplitude of the input current was scaled down so that the combined maximum current sent to both actuators matched the maximum current sent to the single actuator in the translation portion of the experiment. This scaling meant that the vibrations used to display the translation and rotation cues were the same strength.

### E3) Analysis

We created separate linear mixed effects models for the translation and rotation participant response data. The six directions are treated as separate fixed effects and participant as a random effect. We assume a binomial distribution for the responses, which uses the link function:

$$y = log ( \frac{μ}{1 - μ} ) \qquad ( 1 )$$

where μ is the proportion of correct responses. The linear model takes the form:

Y=β₁X₁+β₂X₂+β₃X₃+β₄X₄+β₅X₅+β₆X₆+bS+ε (2)

where βₙ is the fixed effect parameter to model the effect of the nth direction Xₙ, b is a random effects parameter to model the differences across participants S, and is the residual error. Statistical significance was determined using a maximum likelihood test.

The model given in Eq. (2) depends independently on the directions, which are mutually exclusive. The regression in the model examines the change in the likelihood that the response is correct given that more trials are run for a given direction. Therefore, each fixed effect coefficient is a measurement of the estimated increase in the proportion of total correct trials if a new trial is run for a given direction.

### F) Results

### F1) Translation

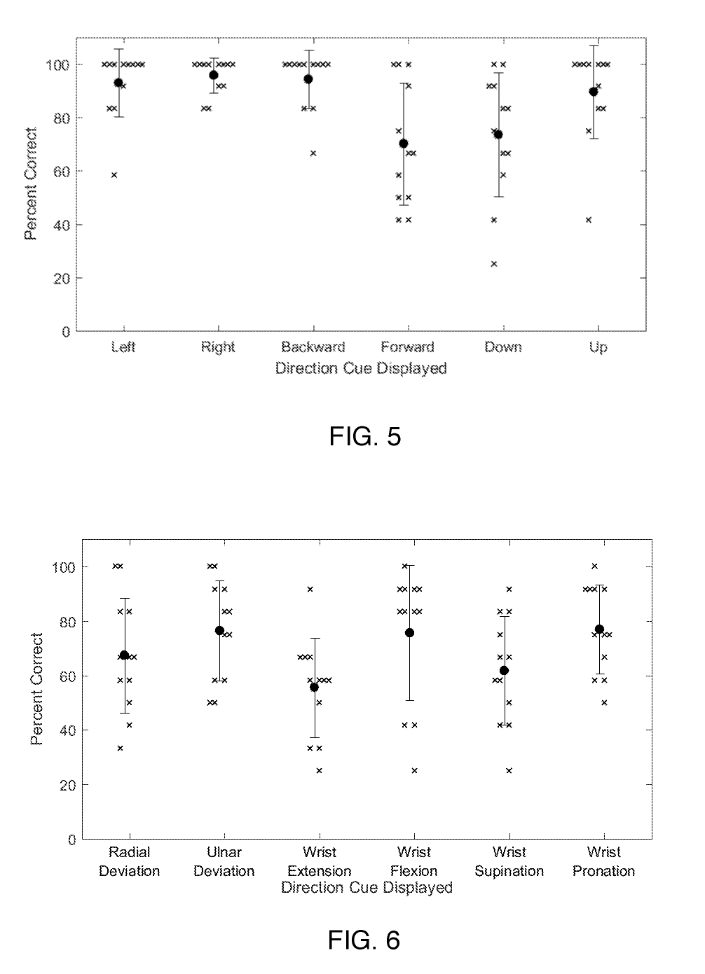

The percentage of correct responses was calculated separately for each participant and condition and the results are shown on FIG. 5. Here filled circles indicate average of all participants, lines show standard deviation, and x's indicate proportion correct for individual participants. The percentages of responses for each condition were then averaged across participants. The resulting confusion matrix of the participants' responses for the translation directions is shown in Table 1. Participants only ever confused a direction cue with its counterpart (i.e. right was only ever confused with left).

TABLE 1
Confusion table showing user responses
for each translation direction.

| | Correct Direction | | | | | |
|---|---|---|---|---|---|---|
| Response | Left | Right | Back | Forward | Down | Up |
| Left | 93.1 | 4.2 | 0.0 | 0.0 | 0.0 | 0.0 |
| Right | 6.9 | 95.8 | 0.0 | 0.0 | 0.0 | 0.0 |
| Back | 0.0 | 0.0 | 94.4 | 29.9 | 0.0 | 0.0 |
| Forward | 0.0 | 0.0 | 5.6 | 70.1 | 0.0 | 0.0 |
| Down | 0.0 | 0.0 | 0.0 | 0.0 | 73.6 | 10.4 |
| Up | 0.0 | 0.0 | 0.0 | 0.0 | 26.4 | 89.6 |

The results of the linear mixed model for the translation responses are shown in Table 2. All directions had positive coefficients, which indicated that the probability of a correct answer would increase with more trials of a given condition. Furthermore, the odds of selecting the correct response (average 86.1%) was significantly greater than chance (16.7%) for all six translation directions (p<0.05).

TABLE 2
Results of fitting linear fixed effects model to
translation responses.

| | Fixed effect | t(858) | p-value |
|---|---|---|---|
| Left | 2.763 | 6.93 | 8.21 × 10⁻¹² |
| Right | 1.656 | 6.97 | 6.16 × 10⁻¹² |
| Backward | 1.002 | 7.01 | 4.89 × 10⁻¹² |
| Forward | 0.236 | 3.27 | 1.12 × 10⁻³ |
| Up | 0.225 | 3.84 | 1.30 × 10⁻⁴ |
| Down | 0.385 | 6.51 | 1.26 × 10⁻¹⁰ |

In the linear mixed model, participant was treated as a random effect. Not all participants performed equally well. Two participants had statistically lower accuracies than average (b=−0.970, t(858)=−2.81, p=0.005), (b=−0.818, t(858)=−2.34, p=0.020). One participant had a statistically higher accuracy than average (b=1.436, t(858)=2.83, p=0.005). These differences are partially due to variations in finger size and geometry, as will be discussed in later sections.

All participants commented that they felt one direction out of a pair more strongly than the other: right cues felt more salient than left cues, backward cues felt more salient than forward cues, and up cues felt more salient than down cues. This perceived discrepancy is mirrored in the percentage correct shown in FIG. 5. We performed a repeated measures ANOVA with participant as the independent variable and direction as the within-subjects factor for each pair of directions to determine systematic variations in the accuracies across the directions. Right had a higher percentage of correct answers (mean 95.8%, SD 6.6%) than left (mean 93.1%, SD 12.7%) (F(1, 10)=0.216, p=0.65), backward had a higher percentage correct (mean 94.4%, SD 10.9%) than forward (mean 70.1%, SD 22.9%) (F(1, 10)=9.82, p=0.011), and up had a higher percentage correct (mean 89.6%, SD 17.5%) than down (mean 73.6%, SD 23.3%) (F(1, 10)=3.84, p=0.077).

The increased strength of the pulling sensation in the right and backward directions over the left and forward directions can at least partially be explained by the actuator placement. Both the right and backward cues were displayed with larger proximal force pulses, whereas the left and forward cues were displayed with larger distal force pulses. The Meissner corpuscles respond more strongly to proximal stimuli than distal stimuli, making proximal signals feel stronger. This nonuniformity in the strength of the signals is also apparent in the larger percentage correct for right than for left and larger percentage correct for backward than for forward. The high percentage for the left cue is due to the overall strength of the right cue; many participants indicated that the left cue was felt weakly, but the right cue was so strong and easily discernible that any cue felt on the thumb that was not right had to be left. The nonuniformity in the perceived strength of the proximal and distal cues could be corrected by amplifying the distal signals so both directions are perceived as the same strength.

The up and down cues had slightly lower accuracies than the other cues, although this difference was not statistically significant. One potential cause of this lower overall accuracy is that the actuator for the up/down cues was mounted to the side of the index finger, which meant less contact between the actuator and the skin and resulted in less efficient transfer of vibration to the finger. The sensations in the up/down directions were also affected by gravity. When the force pulses from the actuator are oriented with gravity, they are felt as slightly stronger because they are assisted by gravity. However, when the force pulses are oriented opposing gravity, they are felt as weaker because they have to work against gravity. Furthermore, the elasticity of the silicone sleeve that attached the actuator to the finger inverted the direction of the force pulses applied to the finger. Since the silicone sleeve was easier to stretch than the skin, the force pulses from the actuator displaced the band in the direction of the pulses and the opposite reaction force pulses would be felt by the finger. Therefore, when the actuator's force pulses were oriented downwards, the user felt an up cue and when the actuator's force pulses were oriented upwards, the user felt a down cue. Thus, combined with the effect of gravity, the up cues felt stronger than the down cues. This is supported by the higher percentage correct for the down cues than the up cues, and was confirmed by all participants who stated that the up cue was easier to determine.

Participants were also asked to rate the difficulty of distinguishing the pairs of translation cues from one another on a five-point Likert scale, with 1 being “very easy” and 5 being “very hard” to distinguish. Participants rated the task of distinguishing left and right (mean=2.18) as being significantly easier (p=0.018) than the task of distinguishing up and down (mean=3.45). The task of distinguishing backward and forward was not rated as significantly harder or easier than the other pairs (mean=2.77, p>0.25).

All participants reported feeling a pulling sensation in the direction of actuation, and many were observed to move their hand to help determine the cue direction. They reported feeling an assisting force when moving hand in the direction of the cue, and a resisting force when moving opposite the direction of the cue. We chose to display a relatively lengthy 3-second-long cue to give the participants time to move before responding.

### F2) Rotation

The percentage of correct responses was calculated separately for each participant and condition, and is shown on FIG. 6. Here filled circles indicate average of all participants, lines show standard deviation, and x's indicate proportion correct for individual participants. The percentages of responses for each condition were then averaged across participants. The resulting confusion matrix of the participants' responses for the rotation directions is shown in Table 3. As in the translation study, participants only ever confused a direction cue with its counterpart (i.e. radial deviation was only ever confused with ulnar deviation).

TABLE 3
Confusion table showing user responses for each rotation direction.

| | Correct Direction | | | | | |
|---|---|---|---|---|---|---|
| Response | Radial | Ulnar | Ext. | Flex. | Sup. | Pron. |
| Radial | 67.4 | 23.6 | 0.0 | 0.0 | 0.0 | 0.0 |
| Ulnar | 32.6 | 76.4 | 0.0 | 0.0 | 0.0 | 0.0 |
| Ext. | 0.0 | 0.0 | 55.6 | 24.3 | 0.0 | 0.0 |
| Flex. | 0.0 | 0.0 | 44.4 | 75.7 | 0.0 | 0.0 |
| Sup. | 0.0 | 0.0 | 0.0 | 0.0 | 61.8 | 22.9 |
| Pron. | 0.0 | 0.0 | 0.0 | 0.0 | 38.2 | 77.1 |

The results of the linear mixed model for the rotation responses are shown in Table 4. All directions had positive coefficients, indicating that the probability of a correct answer would increase with more trials of a given condition. Furthermore, the odds of a correct response was significantly greater than chance for five of the six rotation directions (radial deviation, ulnar deviation, flexion, pronation, and supination) (p<0.05).

TABLE 4
Results of fitting linear fixed effects model to
rotation responses.

| | Fixed effect | t(858) | p-value |
|---|---|---|---|
| Radial | 0.749 | 3.38 | 7.64 × 10⁻⁴ |
| Ulnar | 0.606 | 5.11 | 3.95 × 10⁻⁷ |
| Extension | 0.077 | 1.08 | 0.281 |
| Flexion | 0.293 | 4.98 | 7.68 × 10⁻⁷ |
| Supination | 0.100 | 2.30 | 0.022 |
| Pronation | 0.209 | 5.24 | 2.00 × 10⁻⁷ |

In the linear mixed model, participants were treated as random effects. Not all participants performed equally well. Two participants had statistically lower accuracies than average (b=−0.572, t(858)=−2.36, p=0.019), (b=−0.617, t(858)=−2.55, p=0.011). One participant had a statistically higher accuracy than average (b=0.609, t(858)=2.26, p=0.024).

The participants' ability to discriminate the rotation directions was correlated with their finger size. We measured the circumference of the second phalange of the index finger, middle finger, and thumb. We then binned the participants into two pools based on their average circumference of those three fingers: participants with average finger circumference less than 60 mm (5 participants) and participants with average finger circumference greater than 60 mm (7 participants). We then performed a repeated measures ANOVA on the percentage correct with condition as the independent variable and finger size (small or large) as the within-subjects factor. Participants with smaller fingers had statistically lower accuracies than participants with larger fingers at the rotation experiment (F (1, 28)=11.23, p=0.002). Analyzing the response data for only the participants with larger fingers, the accuracy improves drastically for the radial (81.0%), ulnar (83.3%), and flexion (88.1%) directions. The accuracy improves slightly for the extension (57.1%), supination (63.0%), and pronation (78.6%) directions. There were no statistical differences in the translation experiment for participants with small and large fingers. For our participants, finger size was correlated to gender; four female participants fell in the smaller finger category versus one female participant in the larger finger category.

During the experiment, all participants reported feeling wrist flexion cues more strongly than wrist extension cues. Many participants also reported feeling wrist pronation cues more strongly that wrist supination cues. We performed a repeated measures ANOVA with participant as the independent variable and direction as the within-subjects factor for each pair of conditions. Ulnar deviation had a higher percentage correct (mean 76.4%, SD 18.4%) than radial deviation (mean 67.4%, SD 21.1%) (F(1,10)=0.004, p=0.95), wrist flexion had a higher percentage correct (mean 75.7%, SD 24.7%) than wrist extension (mean 55.6%, SD 18.2%) (F(1,10)=2.12, p=0.18), and pronation had a higher percentage correct (mean 77.1%, SD 16.3%) than supination (mean 61.8%, SD 19.9%) (F(1,10)=0.445, p=0.063).

Participants were asked to rate the difficulty of distinguishing the pairs of rotation cues from one another on a five-point Likert scale, with 1 being “very easy” and 5 being “very hard” to distinguish. Participants rated the task of distinguishing radial and ulnar deviation (mean=3.09) as being significantly easier (p=0.029) than the task of distinguishing flexion and extension (mean=3.77) or pronation and supination (mean=3.77).

Although the differences were not significant, the radial and ulnar extension cues also had the highest combined percentage correct of any of the pairs (71.9%). Actuator placement likely affected why participants found this task easier than the others. The actuators used for radial and ulnar extension were located on the left and right sides of the index finger. The two actuator locations for this cue have the same tactile properties and sensitivity, although directional differences may still occur.

Conversely, the cues for wrist flexion-extension and pronation-supination were displayed on the dorsal side and the palmar side of the finger. Vibrations are sensed differently on these two sides of the finger due to the presence of the finger bones closer to the surface on the dorsal side of the finger and the layers of fatty tissue on the palmar side of the finger. The mounting location on the dorsal side of the finger is more rigid due to the bone, which causes the vibrations to spread out and become difficult to localize. Conversely, on the palmar side of the finger, the thick layers of fatty tissue allow the force pulses to displace the skin in the desired profile with less noise. Furthermore, the actuators on the dorsal side were placed on hairy skin and the actuators on the palmar side were placed on glabrous skin. The actuators on glabrous skin were sensed more strongly than actuators on hairy skin due to the unequal sensitivity of the mechanoreceptors in the two types of skin, which was confirmed by many participants. Therefore, the asymmetric vibrations displayed on the palmar side of the finger created more salient pulling sensations than on the dorsal side of the finger. This could have significantly degraded the torque sensation for those cues, or resulted in torque pairs that felt stronger in one direction than the other, which is evident in the results of the study.

The only rotation condition that was not identified significantly higher than chance was wrist extension. Participants also consistently reported this as the most difficult direction to feel. The wrist extension cue was displayed with distal force pulses on the bottom of the finger and proximal pulses on the top of the finger, as shown in FIGS. 4C-D. In the translation experiment, the forward cue displayed distally on the bottom of the finger was the most difficult to distinguish due to the lower distal activation of the Meissner corpuscles. Thus, the portion of the wrist extension cue on the bottom of the finger was likely perceived more weakly than expected. This was further compounded by the cue on the top of the finger that was weaker due to the lower sensitivity of hairy skin.

All participants reported feeling a twisting sensation in the direction of actuation. Similar to the translation experiment, many participants reported rotating their hand to help them determine which direction the cue was telling them to move.

### G) Discussion

### G1) Translation

Traditional vibration guidance systems use high-frequency vibrations that excite the Pacinian Corpuscles. However, Pacinian Corpuscles have large receptive fields, making it difficult to localize the vibration. Our WAVES device, on the other hand, vibrates at a lower frequency, which excites the Meissner Corpuscles. These mechanoreceptors have much smaller receptive fields, making it significantly easier for users to localize the vibration. Furthermore, our system requires only one actuator per degree of freedom and is easy to scale to multiple dimensions; traditional vibration feedback systems usually requires at least two actuators per degree of freedom, which limits the number of degrees due to spatial sensitivity.

The ease with which participants were able to determine the location of the vibrations can be seen in the confusion matrix; no directions were confused except with their counterpart. The ability to localize the vibration to the individual fingers combined with the salient pulling sensations from the actuators means that the chance of choosing a correct answer becomes 50% since they were able to immediately narrow their choices to a pair of directions. This higher initial probability is a significant improvement over past vibration guidance systems. Participants responded correctly with significantly higher accuracy than chance for all translation directions. The consistently high accuracies for four of the directions (left, right, backward, up) indicate that the participants were able to feel salient pulling sensations in these directions. Our system shows significantly higher accuracy displaying six directions than results presented by others on a multiple direction asymmetric vibration device. This improved performance shows promise for our system that isolates the actuators from each other, making the cues easier to recognize and interpret.

Ideally, all participants would have had similar accuracy identifying directions. However, two participants had statistically poorer performance for the translation cues than the other participants. This discrepancy indicates that the training might not have been sufficient for all participants. It is possible that with more training, all participants would have been able to perform at the same level. Additional training may have also increased the recognition rates of all participants. The accuracies may have been affected by desensitization to vibration, which could be mitigated with more breaks between trials. Desensitization and adaption to the vibrations may limit the real-world applicability of our device; our system would be most effective for tasks where guidance or feedback is needed only intermittently. Variation in actuator placement may also explain some differences between participants. Since the pulling sensation is dependent on skin displacement and excitation of the Meissner corpuscles, the placement of the actuators is very important. Finger size and shape varied widely across participants, so it was not possible to get perfectly consistent actuator placement. A better and more consistent method for attaching actuators to the fingers should be developed in the future.

The results show that the up and down cues were strongly affected by gravity due to the actuator's vertical orientation. In the future, the signals sent to the actuator could be scaled so that the two cues are perceived as the same strength. However, the effect of gravity will change if the user's hand is not in the orientation used in the study, as would be likely in everyday use. Therefore, gravity may play a large role in the perception of the cues as the user moves about the environment. In addition, the inclusion of a distraction task may decrease recognition rates as is seen with traditional vibration devices. However, since the cues presented with our system are intuitive, we expect a smaller decrease in accuracy than for a system with patterned cues.

### G2) Rotation

Although each finger had an actuator on two sides, participants were still able to localize the vibration to an individual finger due to the small receptive fields of the Meissner corpuscles. This localization combined with the noticeable torque sensations allowed participants to easily distinguish between the three pairs of cues by determining which finger the vibration was displayed on. Since no participants confused any of the cues with any other cue except its counterpart, chance for the rotation directions was 50%. Participants responded correctly with significantly higher accuracy than chance for five of the six rotational directions.

Similar to the translation experiment, not all participants performed equally well at the rotation trials. Participants with smaller fingers had statistically lower accuracies than participants with larger fingers. One potential explanation for this discrepancy is that the strength of the torque sensation is dependent on the length of the lever arm between the actuator and the center of rotation in the middle of the finger. This lever arm is shorter for participants with narrower fingers, which would result in smaller torque sensations and could have led to decreased perception and accuracy. The method of attachment could be redesigned to increase the lever arm, effectively increasing the magnitude of the torque sensation, which may lead to increased recognition. For participants with smaller fingers, it is also likely that there was significant vibration interference between the two actuators. In the future, the vibrations strength could be scaled to mitigate this effect.

Another limitation of the torque configurations is the placement of the actuators on the hairy and glabrous skin. Since actuators on glabrous skin were sensed more strongly than actuators on hairy skin, the cues were not as easy to recognize, and some subjects reported feeling a pulling rather than a twisting sensation. In the future, the vibration strength for the two actuators could be scaled so they would be perceived as equal. In addition, mounting locations that do not utilize the hairy skin will be explored. More equal perception between the two actuators for the torque cues will also decrease the confusion between torque cues and simple translation cues, creating the possibility for a single six-degree-of-freedom system.

### G3) Applications

Our system was shown to be effective at displaying both translation and rotation guidance cues. In addition to pedestrian navigation, we can apply these capabilities to additional areas of haptic guidance including rehabilitation and sports training. For example, a user whose arm motion is limited by a stroke could wear our system to receive guidance for creating prescribed arm motions during a rehabilitation session from home without the need for external guidance from a therapist. A user could also wear our system to receive real-time feedback for correcting their yoga poses.

Although the studies we presented here were designed to test the system's effectiveness at guiding a user's motion, the system's ability to display salient ungrounded kinesthetic cues opens up several possibilities for use of our device in other scenarios such as haptic virtual reality and teleoperation. The actuators could be used to display forces that result from contacting or moving virtual objects. The system could be especially compelling for use in gaming to display cues through a tool, like those experienced when fighting with a virtual sword.

### H) Conclusion

In this work we describe WAVES, a Wearable Asymmetric Vibration Excitation System for displaying haptic direction guidance cues. Unlike traditional vibration feedback that requires users to interpret a binary cue or match a pattern of vibration, WAVES creates intuitive, easy to interpret direction cues through pulling and twisting sensations. With our approach, only six actuators are necessary to provide twelve distinct direction cues. Users felt compelled to move or rotate their hand in the direction of the guidance cues, and the sensation was amplified by motion with or against the direction of the cue. Actuator placement and contact with the skin was central to creating a salient pulling or twisting sensation. The directional properties of the Meissner Corpuscles created an unequal perception of the directions. Furthermore, the rotation directions were perceived more strongly by participants with larger fingers, partially due to the presence of a larger lever arm creating a larger physical torque.

### I) Further Developments

The strength of the pulling sensation provided by asymmetric vibrations is strongly affected by the coupling between the actuator and the skin. When the actuator is held in the hand, it is important for there to be as much skin contact as possible and for the actuator to be held lightly so that the skin is able to attain its maximum displacement. The coupling between actuator and skin become significantly more complex, however, when the actuator is directly mounted to the user's hand. The actuator is preferably mounted so that it is flat on the skin and has even contact along its length. The strongest pulling sensation is achieved when the actuator mounted directly along a bone in the hand or fingers.

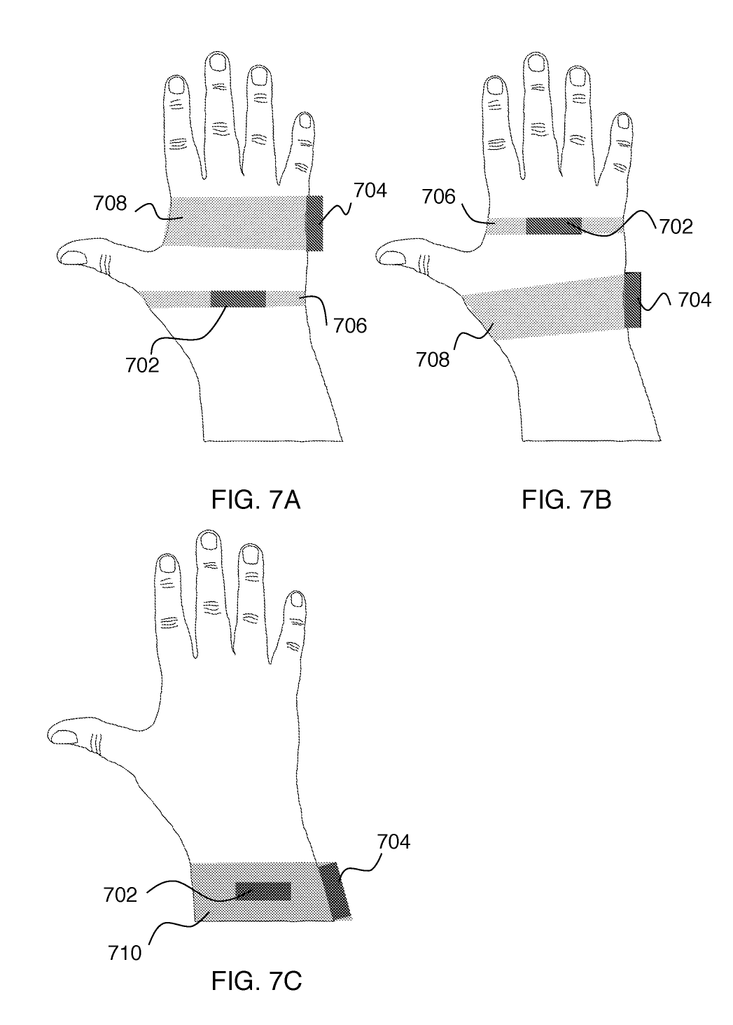

FIGS. 7A-C show three possible mounting implementations for two actuators (702, 704) on the hand, which would provide two axes of direction cues. In the example of FIG. 7A, left-right actuator 702 is held to the back of the hand by strap 706 and forward-backward actuator 704 is held to the side of the hand by strap 708. The example of FIG. 7B differs from the example of FIG. 7A in the location of these two actuators as shown. In the example of FIG. 7C, these two actuators are held in contact with the wrist using a single strap 710 for both actuators.

It is important to note that in these implementations the actuators are non-collocated (i.e. they are located on different parts of the hand). This difference in mounting location means that the vibrations from one actuator are not felt at the location of the other actuator. Therefore, the separate axes of vibration are not physically summing to a multi-dimensional vibration signal. Rather, the vibrations are sensed separately by the mechanoreceptors in the separate parts of the hand, and the pulling sensations are then perceptually combined onto a single axis, as described in the Summary section above.

Although the detailed example given above relates to asymmetric vibration actuators disposed on the hand, disposing two or more asymmetric vibration actuators on other parts of the body is also possible. In order to provide perceptual combination of actuator pulling sensations, the two or more actuators will typically need to be on the same body part.

Multiple actuators could be attached to the wrist as in the example of FIG. 7C to display cues with multiple degrees of freedom. A single actuator can be used to display a translation cue, and a pair of parallel-mounted actuators can be used to display rotation cues. The wristband would be constructed such that the actuators were not rigidly coupled to one another and were free to remove relative to one another for at least a few millimeters of travel. The wristband would be made of an elastic or fabric material. An adhesive such as tape or glue could be used between the actuator and the skin to better transmit the skin deformation.

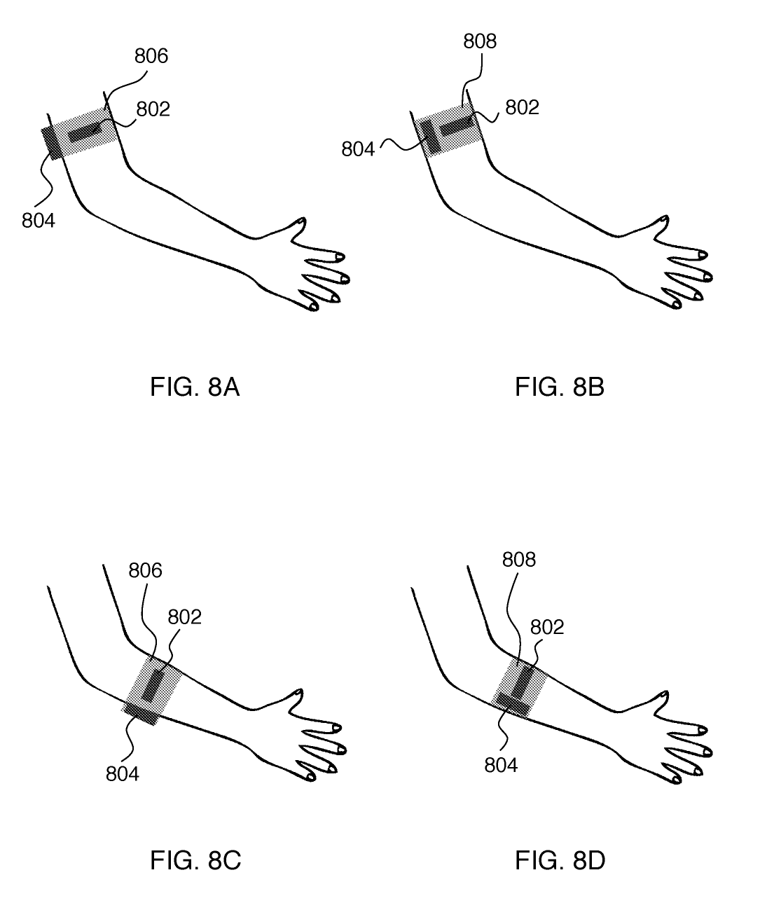

Multiple actuators (802, 804) displaying multiple degrees of freedom could be attached to either the upper arm (FIGS. 8A-B) or lower arm (FIGS. 8C-D) using an elastic band (806, 808) or the sleeve of a shirt. In the example of FIG. 8A, forward-backward actuator 802 is held to the outside of the upper arm and up-down actuator 804 is held to the back of the upper arm by strap 806. The example of FIG. 8B differs from the example of FIG. 8A in the location and proximity of the two actuators as shown. In the example of FIG. 8C, forward-backward actuator 802 is held to the outside of the lower arm and up-down actuator 804 is held to the back of the lower arm by strap 806. The example of FIG. 8D differs from the example of 8C in the location and proximity of the two actuators as shown. In either configuration, the actuator should make direct contact with the skin. A single actuator can be used to display a translation cue, and a pair of parallel-mounted actuators can be used to display rotation cues.

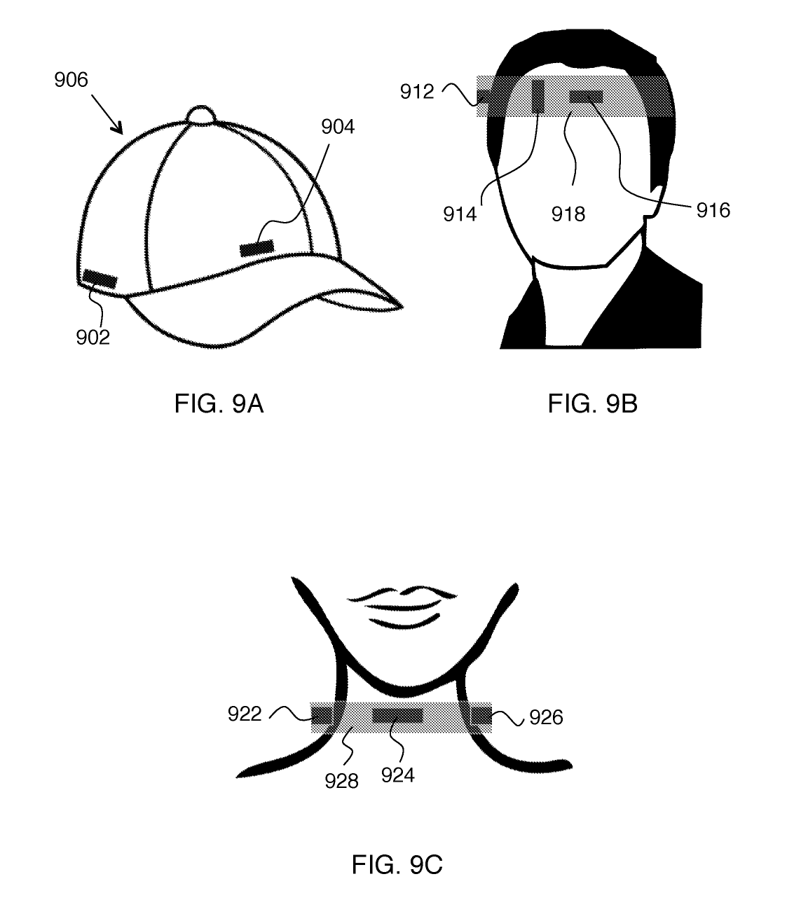

Multiple actuators could be attached to the head using a hat (FIG. 9A) or headband (FIG. 9B) configuration. The example of FIG. 9A shows actuators 902 and 904 mounted on a hat 906. The example of FIG. 9B shows actuators 912, 914, and 916 mounted on a headband 918. A single actuator can be used to display a translation cue, and a pair of parallel-mounted actuators can be used to display rotation cues. The actuators should be in direction contact with the skin, ideally the non-hairy skin of the forehead. The headband should be made of an elastic material, and the hat can be made of either a fabric or elastic material. An adhesive such as tape or glue could be used between the actuator and the skin to better transmit the skin deformation.

Multiple actuators could be attached to the neck using an elastic neck band, as in the example of FIG. 9C. Here actuators 922, 924, and 926 are mounted on headband 928. A single actuator can be used to display a translation cue, and a pair of parallel-mounted actuators can be used to display rotation cues. The actuators should be in direct contact with the skin, and an adhesive can be used between the actuator and skin to increase transmission of skin deformation.

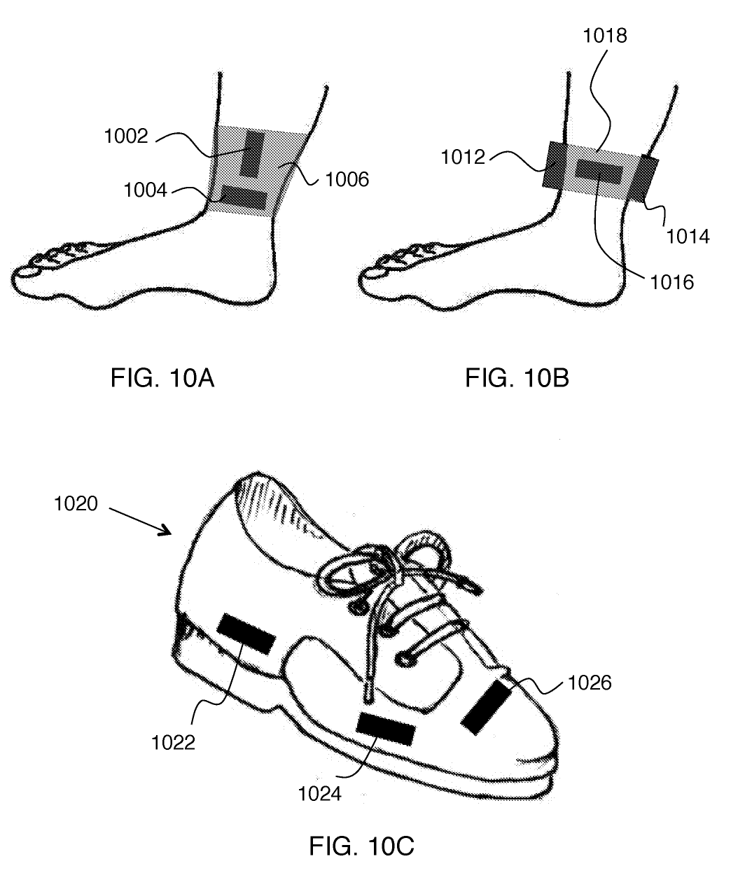

Multiple actuators displaying multiple degrees of freedom could be attached to the ankle using an elastic band, as in the examples of FIGS. 10A and 10B. In the example of FIG. 10A, actuators 1002 and 1004 are held in position with elastic band 1006. In the example of FIG. 10B, actuators 1012, 1014 and 1016 are held in position by elastic band 1018. A single actuator can be used to display a translation cue, and a pair of parallel-mounted actuators can be used to display rotation cues. The actuators should be in direct contact with the skin, and an adhesive can be used between the actuator and skin to increase transmission of skin deformation.

Multiple actuators displaying multiple degrees of freedom could be attached to the foot using a shoe, as shown on FIG. 10C. In this example, actuators 1022, 1024 and 1026 are mounted on shoe 1020. The actuators should be mechanically decoupled from the shoe so that they do not try to accelerate the mass of the shoe when excited. This can be done by placing an elastic material between the actuators and the shoe so that the force imparted by the actuators goes to stretching the material and not to accelerating the shoe.

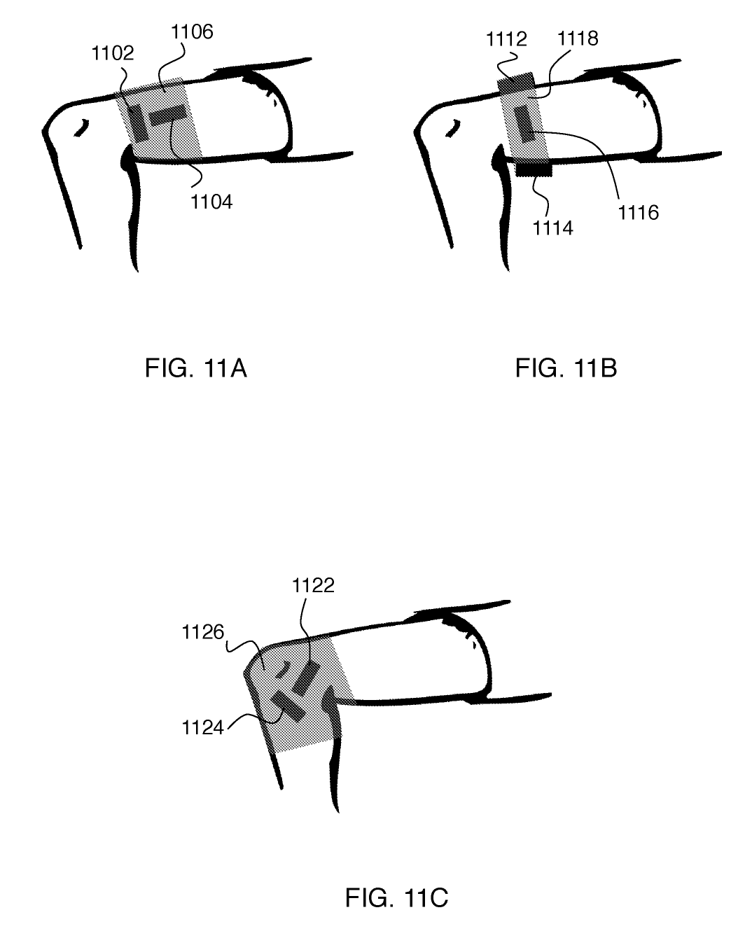

Multiple actuators displaying multiple degrees of freedom could be attached to the knee or upper leg using an elastic band, as in the examples of FIGS. 11A-C. FIG. 11A shows elastic band 1106 holding actuators 1102 and 1104 in position. FIG. 11B shows elastic band 1118 holding actuators 1112, 1114, and 1116 in position. FIG. 11C shows elastic band 1126 holding actuators 1122 and 1124 in position. A single actuator could be used to display a translation direction cue, and a pair of parallel actuators could be used to display a rotation cue. An adhesive could be used between the actuator and skin to increase the transmission of skin deformation, and to keep the actuators in place during motion of the knee.

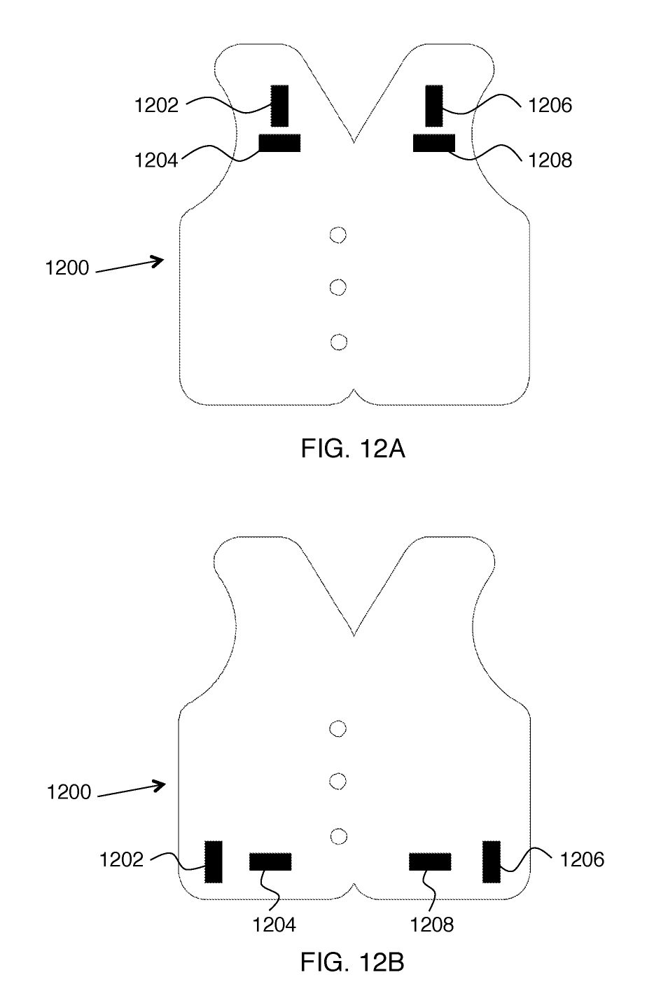

Multiple actuators displaying multiple degrees of freedom could be attached to the chest using a vest, as in the examples of FIGS. 12A-B. FIG. 12A shows vest 1200 holding actuators 1202, 1204, 1206, and 1208 in position. FIG. 12B shows vest 1200 holding actuators 1202, 1204, 1206, and 1208 in position in different locations than in the example of FIG. 12A. The actuators could be placed a multiple locations across the upper and lower chest. Since the chest is a large area, the actuators could be used to display spatial information as well.

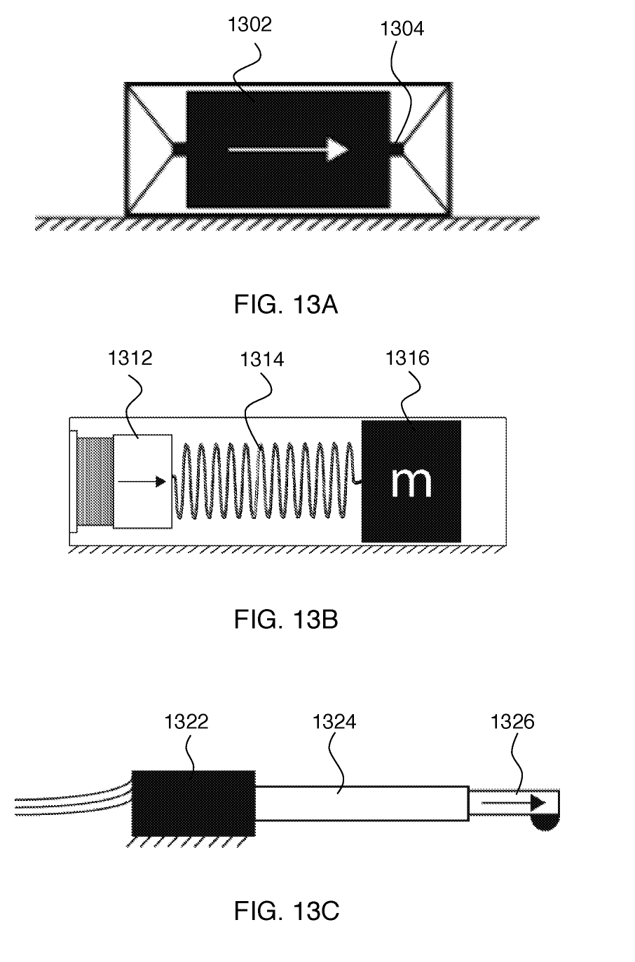

In the examples given above, voice coil actuators are employed. FIG. 13A schematically shows a voice coil actuator where members 1302 and 1304 are driven into relative motion by an interaction between current in a coil and a magnetic field from a permanent magnet. The voicecoil could include a stationary electromagnetic coil and a moving magnet, or a stationary magnet and a moving electromagnetic coil. The permanent magnet is centered inside the electromagnetic coil using flexible membranes or a bearing. The stationary component makes contact with the user. The position and speed of the moving component would be controlled by varying the sign and magnitude of the current sent to the coil. The moving component would be controlled to move quickly in one direction, and slowly in the return direction. However, practice of the invention does not depend critically on the kind of actuator employed. The following description relates to several alternative actuators that can be used in embodiments of the invention.

Linear resonant actuators (LRA)—Asymmetric skin deformation profiles could be induced using a linear resonant actuator. This actuator would be driven with a signal that moved the mass inside the actuator quickly in one direction and slowly in the return direction. The optimal drive signal will be dependent on the frequency characteristics of the actuator. The LRA will create asymmetric force profiles that will be transmitted to asymmetric skin deformation when the actuator is worn or held. One actuator would be needed per degree of freedom.

Asymmetric skin deformation profiles could be induced using a mass 1316 on a spring 1314, as in the example of FIG. 13B. An electromechanical actuator 1312 (e.g., a voice coil) would be used to control the input signal to the spring such that the attached mass moved quickly in one direction and slowly in the return direction. The optimal drive signal will be dependent on the mass and spring constant of the system. This system will create asymmetric force profiles that will be transmitted to asymmetric skin deformation when the actuator is worn or held. One actuator would be needed per degree of freedom.

Asymmetric skin deformation could be applied directly using linear servos, as in the example of FIG. 13C. Here 1322 schematically shows the servo control, and linear actuator 1324 extends or retracts member 1326 as commanded by controller 1322. The servos would be actuated quickly in one direction, and slowly in the return direction. The member 1326 could be attached to platform that was held against the wearer's skin. The servo could either be grounded to a different part of the body in a wearable device, or it could be grounded to a handle in a holdable device. One actuator would be needed per degree of freedom.

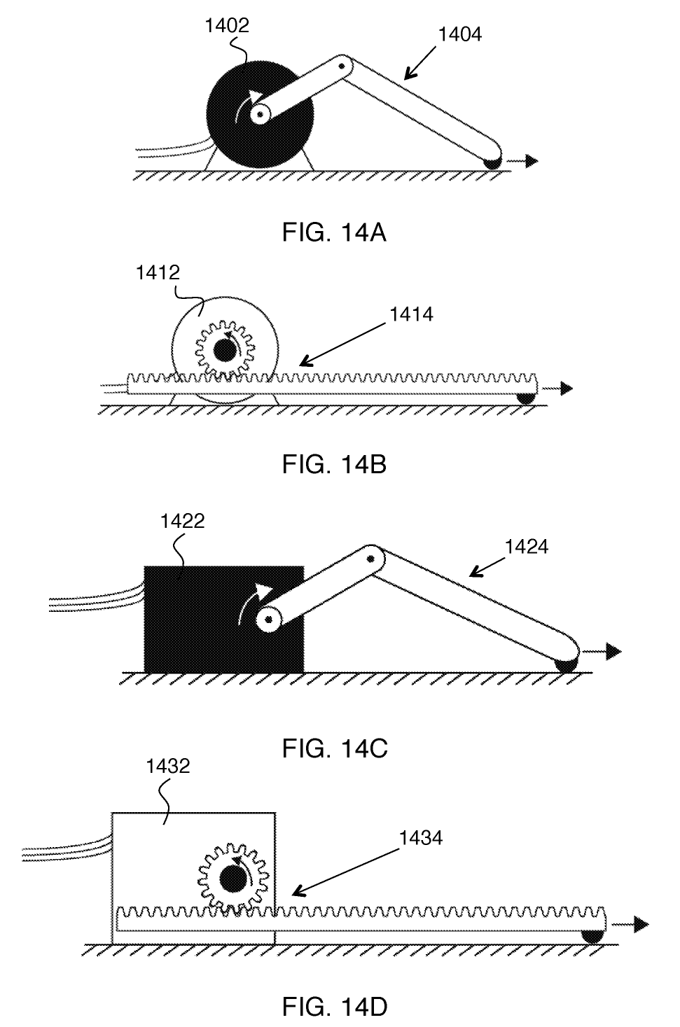

Asymmetric skin deformation could be applied directly using a motor, as in the examples of FIGS. 14A-B. The rotational motion of the motor (1402 or 1412) would be mechanically transformed to linear motion. Potential mechanisms include a slider-crank mechanism (1404 on FIG. 14A)) or a rack-and-pinion system (1414 on FIG. 14B). The motor would be rotated quickly in one direction, and slowly in the return direction. A platform or rubber nodule would be attached to the end of the linear mechanism to deform the skin. One actuator would be needed per degree of freedom.

Asymmetric skin deformation could be applied directly using a rotary servo, as in the examples of FIGS. 14C-D. The servo (1422 or 1432) would be rotated quickly in one direction, and slowly in the return direction. The rotational motion would be mechanically converted to linear motion (e.g. through a slider-crank mechanism 1424 on FIG. 14C or a rack-and-pinion system 1434 on FIG. 14D), which would then deform the user's skin. One actuator would be needed per degree of freedom.

An additional method of creating asymmetric skin displacement could be realized by directly transmitting force to the fingertips through a linkage or multiple linkages. These linkages would hold a platform in contact with the fingertip. The platform would then be moved asymmetrically (faster in one direction, slower in the return direction) using motors. This asymmetric motion would cause faster skin deformation in one direction, resulting in a direction cue in the faster direction. The platform could be actuated to display either a single-axis direction cue, or direction cues along an arbitrary axis depending on the number of linkages and motors. This system could also be used to display rotation cues by rotating the platform.

An additional method of creating asymmetric skin displacement could be realized by using a flywheel device to impart torque pulses to the user's fingertips. These torque pulses would be created by controlling the angular momentum of the flywheels through adjustments to their speed and orientation. The flywheels would be attached to or held in the user's fingers such that when a torque was applied, the skin on the user's fingertips was stretched. The device could be controlled to create asymmetric torque pulses that had larger magnitude torques in the desired direction than in the return direction. These torque pulses would then be transmitted to asymmetric skin deformation at the user's fingertips. The flywheel device could be constructed such that it was able to display a single-axis direction cue, or direction cues along an arbitrary axis.

1. A haptic feedback device comprising:
two or more 1-D actuators driven with asymmetric vibrations to provide force cues to a user, wherein at least two of the actuators are configured to provide a vector force cue by combination of their outputs;
wherein the two or more 1-D actuators are mechanically isolated from each other.

2. The haptic feedback device of claim 1, further comprising a rigid substrate, wherein the two or more 1-D actuators are mounted to the rigid substrate via a flexible and mechanically isolating medium configured to mechanically decouple the two or more actuators from each other.

3. The haptic feedback device of claim 1, further comprising one or more elastic fabric members configured to hold at least one of the 1-D actuators in contact with skin of a user in operation.

4. The haptic feedback device of claim 1, wherein the elastic fabric members do not stretch in actuation directions of their corresponding 1-D actuators.

5. The haptic feedback device of claim 1, further comprising one or more elastic sleeve members configured to hold at least one of the 1-D actuators in contact with skin of a user in operation.

6. The haptic feedback device of claim 1, wherein the 1-D actuators are configured to be mounted on a human body part selected from the group consisting of: finger, hand, wrist, arm, head, neck, ankle, foot, knee, and chest.

7. The haptic feedback device of claim 1, further comprising at least one pair of linear actuators disposed to deliver substantially equal and opposite forces to skin of a user to create a haptic rotation cue.

8. The haptic feedback device of claim 1, wherein the two or more 1-D actuators are voice coil actuators.

9. The haptic feedback device of claim 1, wherein the two or more 1-D actuators are selected from the group consisting of: an oscillating mass on a spring where the position of the mass is controlled by a motor or a voice coil; linear servos; rotary motors having a mechanical linkage to translate rotation to displacement of skin; rotary servo motors having a mechanical linkage to translate rotation to displacement of skin; and linear resonant actuators.
